(19) United States
(12) Patent Application Publication
(10) Pub. No.: US 2021/0026531 A1
(43) Pub. Date: Jan. 28, 2021

(54) COLLABORATIVE DRAWING METHOD AND ELECTRONIC DEVICE THEREFOR

(71) Applicant: Samsung Electronics Co., Ltd., Suwon-si (KR)

(72) Inventors: Md Shamsul Arifin MOZUMDER, Dhaka (BD); Sifat Afroj MOON, Manhattan, KS (US); Jewel NANDY, Dhaka (BD); Md Ashaduzzaman Rubel MONDOL, Gazipur (BD); Samsad Ul ISLAM, Dhaka (BD)

(21) Appl. No.: 17/070,319

(22) Filed: Oct. 14, 2020

Related U.S. Application Data
(63) Continuation of application No. 15/262,676, filed on Sep. 12, 2016.

(30) Foreign Application Priority Data
Oct. 29, 2015 (KR) 10-2015-0151280

(51) Int. Cl. G06F 3/0488; H04L 29/06; G06T 11/00; G06F 3/0484

(52) U.S. Cl. CPC G06F 3/04883; G06F 3/04845; G06T 11/00; H04L 29/06027

(57) ABSTRACT

An electronic device and a method for collaborative drawing in which multiple users participate with their own electronic devices are provided. The electronic device for drawing a picture collaboratively includes a transceiver for sharing information with at least one other electronic device, a touchscreen for receiving a user input and displaying an image corresponding to the user input, a memory for storing a drawing application, and a processor. The processor is configured to control for connecting to the at least one other electronic device via the drawing application, receiving the user input through the touchscreen, detecting an event occurring during the user input based on predetermined event occurrence conditions, when the event is detected, sharing information on the event with the at least one other electronic device in real time, and displaying information on the detected event on the touchscreen.

### CROSS-REFERENCE TO RELATED APPLICATION(S)

This application is a continuation application of prior application Ser. No. 15/262,676, filed on Sep. 12, 2016, which is based on and claims priority under 35 U.S.C. § 119(a) of a Korean patent application number 10-2015-0151280, filed on Oct. 29, 2015, in the Korean Intellectual Property Office, the disclosure of which is incorporated by reference herein in its entirety.

### TECHNICAL FIELD

The present disclosure relates to a method and electronic device for collaborative drawing in which multiple users participate with their own electronic devices.

### BACKGROUND

With the advance of communication technology, cooperative activities are increasing in the digital realm. A cooperative digital activity may denote an activity in which multiple electronic devices participate for one task. For example, a plurality of electronic devices may share data in real time. The advance of communication technology has made it possible for the electronic devices to share a large volume of data more quickly. Such a real time data sharing capability allows multiple users to draw a picture in a cooperative manner. For example, two geographically distant users can participate in drawing a picture in real time.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a collaborative drawing method and electronic device that is capable of subdividing the drawing information and transmitting the subdivided drawing information to other participants' devices consecutively to achieve real-time operation. In a collaborative drawing session, if an action is taken by a participant's device, a signal corresponding to the action may be transmitted to another participant's device. For example, a first participant's device and a second participant's device may be in the state of being connected to each other via a drawing application. If the first participant makes a stroke with the first participant's device, the information corresponding to the stroke may be transmitted to the second participant's device. The stroke information may include information on the brush and color concerning the stroke (hereinafter referred to as brush information and color information, respectively). That is, in the method according to the related art, the electronic device may transmit the information on the stroke that has been made by the user (including type and color of the brush) to other participants' devices. However, the electronic device transmits the stroke information after the stroke has been completed therefore, the stroke information is of sufficiently large volume to increase the possibility of transmission failure.

In accordance with an aspect of the present disclosure, an electronic device for drawing a picture collaboratively is provided. The electronic device includes a radio communication unit for sharing information with at least one other electronic device, a touchscreen for receiving a user input and displaying an image corresponding to the user input, a memory for storing a drawing application, and a processor that controls the electronic device to connect to the at least one other electronic device via the drawing application, receive the user input through the touchscreen, detect an event occurring during the user input based on predetermined event occurrence conditions, share, when the event is detected, information on the event with the at least one other electronic device in real time, and display information on the shared event on the touchscreen.

In accordance with another aspect of the present disclosure, a collaborative drawing method of an electronic device is provided. The collaborative drawing method includes connecting the electronic device to at least one other electronic device via a drawing application, receiving a user input through a touchscreen, detecting an event occurring during the user input based on predetermined event occurrence conditions, sharing, when the event is detected, information on the event with the at least one other electronic device in real time, and displaying information on the event shared with the at least one other electronic device on the touchscreen.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a network environment including electronic devices according to various embodiments of the present disclosure;

FIG. 2 is a block diagram illustrating a configuration of an electronic device according to various embodiments of the present disclosure;

FIG. 3 is a block diagram illustrating a configuration of a program module according to various embodiments of the present disclosure;

FIGS. 4A and 4B are diagrams for explaining a procedure for establishing a collaborative drawing session among multiple electronic devices according to various embodiments of the present disclosure;

FIGS. 5A to 5D are diagrams illustrating various screen displays for explaining how to draw pictures collaboratively according to various embodiments of the present disclosure;

FIG. 6 is a flowchart illustrating a collaborative drawing method according to various embodiments of the present disclosure;

FIG. 7 is a flowchart illustrating a procedure of establishing a connection between electronic devices for drawing a picture collaboratively according to various embodiments of the present disclosure;

FIGS. 8A and 8B are a flowchart illustrating a collaborative drawing procedure according to various embodiments of the present disclosure; and

FIGS. 9A to 9H are diagrams illustrating various screen displays for explaining a collaborative drawing procedure according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details assist in that understanding but these are to be regarded as merely exemplary. Accordingly, those of ordinary skill in the art will recognize that various changes and modifications of the various embodiments described herein can be made without departing from the spirit and scope of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the present disclosure, the terms such as “include”, “have”, “may include” or “may have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “(operatively or communicatively) coupled to” or “connected to” another component, the component may be directly coupled or connected to another component or a new component may exist between the component and another component. In contrast, when it is stated that a component is “directly coupled to” or “directly connected to” another component, a new component does not exist between the component and another component. In the present disclosure, the expression “configured (or set) to do” may be used to be interchangeable with, for example, “suitable for doing,” “having the capacity to do,” “designed to do,” “adapted to do,” “made to do,” or “capable of doing.” The expression “configured (or set) to do” may not be used to refer to only something in hardware for which it is “specifically designed to do.” Instead, the expression “a device configured to do” may indicate that the device is “capable of doing” something with other devices or parts. For example, the expression “a processor configured (or set) to do A, B and C” may refer to a dedicated processor (e.g., an embedded processor) or a generic-purpose processor (e.g., central processing unit (CPU) or application processor (AP)) that may execute one or more software programs stored in a memory device to perform corresponding functions.

An electronic device according to various embodiments of the present disclosure may be a device including an antenna. For example, the electronic device may be one or more of the following: a smart phone, a tablet personal computer (PC), a mobile phone, a video phone, an e-book reader, a desktop PC, a laptop PC, a netbook computer, a personal digital assistant (PDA), portable multimedia player (PMP), moving picture experts group layer-3 (MP3) player, a mobile medical application, a camera, and a wearable device (for example, a head-mounted-device (HMD), such as electronic glasses, electronic clothes, an electronic bracelet, an electronic necklace, an electronic appcessary, an electronic tattoo, and a smart watch).

According to some embodiments, the electronic device may be a smart home appliance having an antenna. The smart home appliance may include at least one of the following: a television (TV), a digital video disk (DVD) player, an audio player, an air conditioner, a cleaner, an oven, a microwave oven, a washing machine, an air purifier, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of the following: various types of medical devices (for example, magnetic resonance angiography (MRA), magnetic resonance imaging (MRI), computed tomography (CT), a scanner, an ultrasonic device and the like), a navigation device, a global positioning system (GPS) receiver, an event data recorder (EDR), a flight data recorder (FDR), a vehicle infotainment device, electronic equipment for a ship (for example, a navigation device for ship, a gyro compass and the like), avionics, a security device, a head unit for a vehicle, an industrial or home robot, an automatic teller machine (ATM) of financial institutions, and a point of sale (POS) device of shops.

According to some embodiments, the electronic device may include at least one of the following: furniture or a part of a building/structure, an electronic board, an electronic signature receiving device, a projector, and various types of measuring devices (for example, a water meter, an electricity meter, a gas meter, a radio wave meter and the like), which are equipped with an antenna. The electronic device according to various embodiments of the present disclosure may also be a combination of the devices listed above. Further, the electronic device according to various embodiments of the present disclosure may be a flexible device. It is apparent to those skilled in the art that the electronic device according to various embodiments of the present disclosure is not limited to the above described devices.

Hereinafter, an electronic device according to various embodiments will be discussed with reference to the accompanying drawings. The term se skilled in the art that the electronic device according to various embodiments of the present meter and the e (e.g., an artificial intelligence electronic device) using an electronic device.

The definition of “canvas” in the present disclosure is a drawing board in an electronic device for drawing pictures. When there is a plurality of electronic devices that is being drawn on simultaneously, the screen displayed on each electronic device can be the same canvas. That is, when a plurality of electronic devices is being drawn on simultaneously, the same picture can be displayed on each of the electronic devices.

The definition of “drawing application” in the present disclosure is any application with which a picture can be drawn in response to a user input on an electronic device. For example, drawing applications include all applications in which an image can be drawn in response to an input point of a user input.

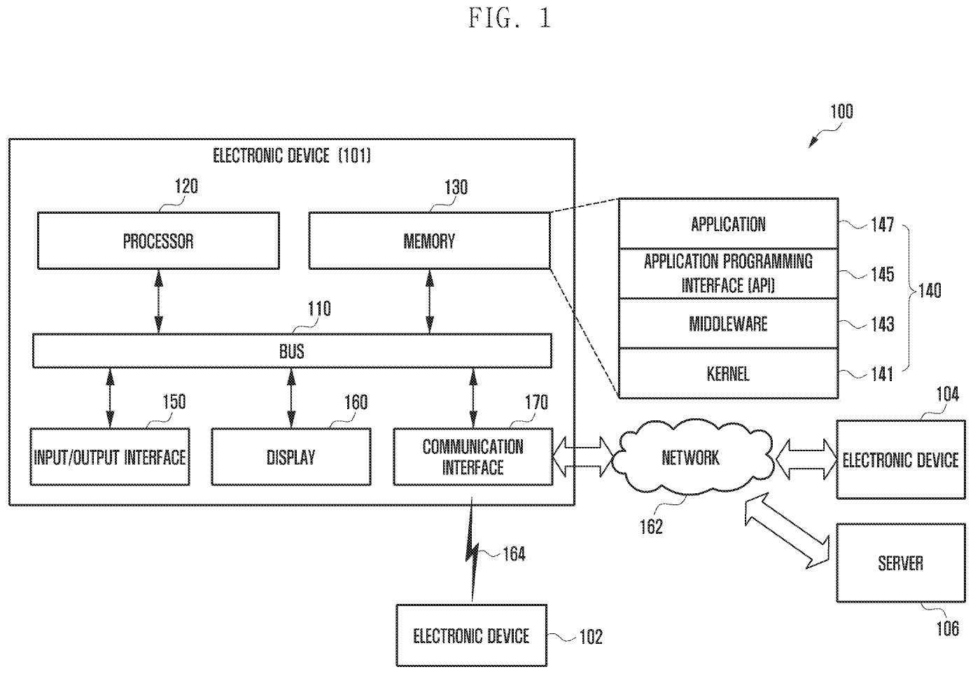

FIG. 1 illustrates a network environment 100 including an electronic device 101 according to various embodiments of the present disclosure.

Referring to FIG. 1, the electronic device 101 may include a bus 110, a processor 120, a memory 130, an input/output interface 150, a display 160, and a communication interface 170. According to some embodiments, at least one of the above described components may be omitted from the electronic device 101 or another component may be further included in the electronic device 101.

The bus 110 may be a circuit connecting the above described components 120, 130, 150, 160, and 170 and transmitting communications (e.g., control messages and/or data) between the above described components.

The processor 120 is capable of including one or more of the following: a central processing unit (CPU), an application processor (AP), and a communication processor (CP). The processor 120 is capable of controlling at least one of other components of the electronic device 101 and/or processing data or operations related to communication.

The memory 130 is capable of including volatile memory and/or non-volatile memory. The memory 130 is capable of storing data or commands related to at least one of other components of the electronic device 101. According to an embodiment, the memory 130 is capable of storing software and/or a program module 140. For example, the program module 140 is capable of including a kernel 141, middleware 143, application programming interface (API) 145, application programs (or applications) 147, etc. The kernel 141, middleware 143 or at least part of the API 145 may be called an operating system (OS).

The kernel 141 is capable of controlling or managing system resources (e.g., the bus 110, processor 120, memory 130, etc.) used to execute operations or functions of other programs (e.g., the middleware 143, API 145, and application programs 147). The kernel 141 provides an interface capable of allowing the middleware 143, API 145, and application programs 147 to access and control/manage the individual components of the electronic device 101.

The middleware 143 is capable of mediating between the API 145 or application programs 147 and the kernel 141 so that the API 145 or the application programs 147 can communicate with the kernel 141 and exchange data therewith. The middleware 143 is capable of processing one or more task requests received from the application programs 147 according to the priority. For example, the middleware 143 is capable of assigning a priority for use of system resources of the electronic device 101 (e.g., the bus 110, processor 120, memory 130, etc.) to at least one of the application programs 147. For example, the middleware 143 processes one or more task requests according to a priority assigned to at least one application program, thereby performing scheduling or load balancing for the task requests.

The API 145 refers to an interface configured to allow the application programs 147 to control functions provided by the kernel 141 or the middleware 143. The API 145 is capable of including at least one interface or function (e.g., instructions) for file control, window control, image process, text control, or the like.

The input/output interface 150 is capable of transferring instructions or data, received from the user or external devices, to one or more components of the electronic device 101. The input/output interface 150 is capable of outputting instructions or data, received from one or more components of the electronic device 101, to the user or external devices.

The display 160 is capable of including a liquid crystal display (LCD), a flexible display, a transparent display, a light emitting diode (LED) display, an organic LED (OLED) display, micro-electro-mechanical systems (MEMS) display, an electronic paper display, etc. The display 160 is capable of displaying various types of content (e.g., texts, images, videos, icons, symbols, etc.). The display 160 may also be implemented with a touch screen. In this case, the display 160 is capable of receiving touches, gestures, proximity inputs or hovering inputs, via a stylus pen, or a user's body.

The communication interface 170 is capable of establishing communication between the electronic device 101 and an external device (e.g., a first external device 102, a second electronic device 104, or a server 106). For example, the communication interface 170 is capable of communicating with an external device (e.g., a second external device 104 or a server 106) connected to the network 162 via wired or wireless communication.

Wireless communication may employ, as cellular communication protocol, at least one of the following: long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM). Wireless communication may also include short-wireless communication 164. Short-wireless communication 164 may include at least one of the following: wireless fidelity (WiFi), Bluetooth (BT), near field communication (NFC), magnetic secure transmission (MST), and global navigation satellite system (GNSS). The GNSS may include at least one of the following: global positioning system (GPS), Global Navigation Satellite System (Glonass), Beidou Navigation Satellite System (Beidou), Galileo, the European global satellite-based navigation system, according to GNSS using areas, bandwidths, etc. In the present disclosure, “GPS” and “GNSS” may be used interchangeably. Wired communication may include at least one of the following: universal serial bus (USB), high definition multimedia interface (HDMI), recommended standard 232 (RS-232), and plain old telephone service (POTS). The network 162 may include at least one of the following: a telecommunications network, e.g., a computer network (e.g., local area network (LAN) or wide area network (WAN)), the Internet, and a telephone network.

The first and second external electronic devices 102 and 104 are each identical to or different from the electronic device 101, in terms of type. According to an embodiment, the server 106 is capable of including a group of one or more servers. According to various embodiments, part or all of the operations executed on the electronic device 101 may be executed on another electronic device or a plurality of other electronic devices (e.g., electronic devices 102 and 104 or a server 106). According to an embodiment, when the electronic device needs to perform a function or service automatically or according to a request, it does not perform the function or service, but is capable of additionally requesting at least part of the function related to the function or service from other electronic device (e.g., electronic devices 102 and 104 or a server 106). The other electronic device (e.g., electronic devices 102 and 104 or a server 106) is capable of executing the requested function or additional functions, and transmitting the result to the electronic device 101. The electronic device 101 processes the received result, or further proceeds with additional processes, to provide the requested function or service. To this end, the electronic device 101 may employ cloud computing, distributed computing, or client-server computing technology.

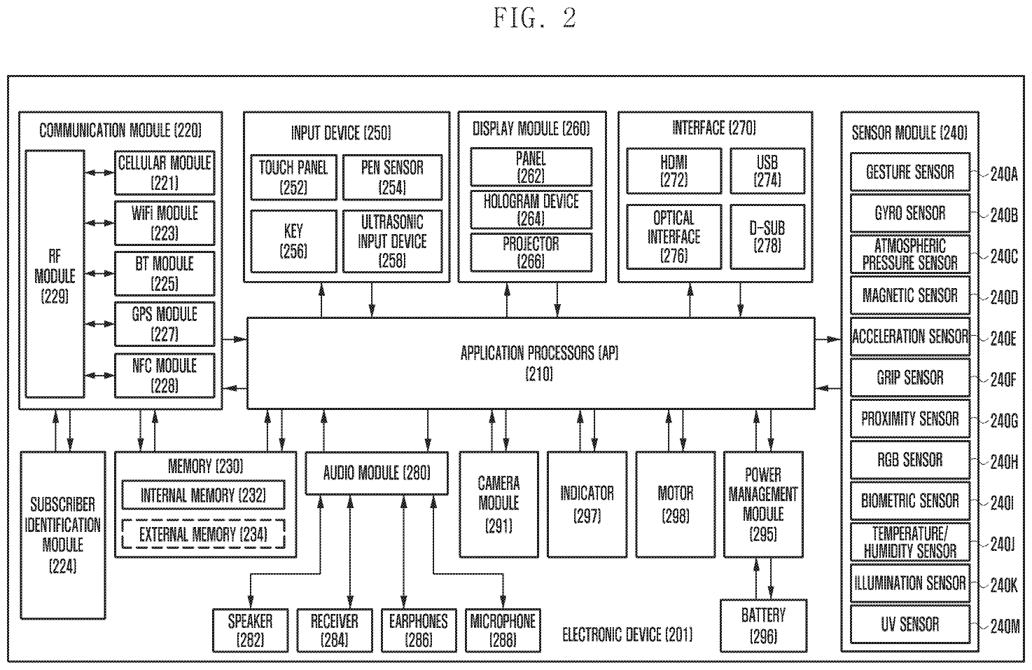

FIG. 2 is a detailed block diagram showing a configuration of an electronic device 201 according to various embodiments of the present disclosure. For example, the electronic device 201 is capable of including part or all of the components in the electronic device 101 shown in FIG. 1. The electronic device 201 is capable of including one or more processors 210 (e.g., Application Processors (APs)), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

Referring to FIG. 2, the processor 210 is capable of driving, for example, an operating system (OS) or an application program to control a plurality of hardware or software components connected to the processor 210, processing various data, and performing operations. The processor 210 may be implemented as, for example, a system on chip (SoC). According to an embodiment, the processor 210 may further include a graphic processing unit (GPU) and/or an image signal processor (ISP). The processor 210 may also include at least part of the components shown in FIG. 2, e.g., a cellular module 221. The processor 210 is capable of loading commands or data received from at least one of other components (e.g., a non-volatile memory) on a volatile memory, processing the loaded commands or data. The processor 210 is capable of storing various data in a non-volatile memory.

The communication module 220 may include the same or similar configurations as the communication interface 170 shown in FIG. 1. For example, the communication module 170 is capable of including a cellular module 221, WiFi module 223, Bluetooth (BT) module 225, GNSS module 227 (e.g., a GPS module, Glonass module, Beidou module or Galileo module), NFC module 228, and radio frequency (RF) module 229.

The cellular module 221 is capable of providing a voice call, a video call, a short message service (SMS) service, an Internet service, etc., through a communication network, for example. According to an embodiment, the cellular module 221 is capable of identifying and authenticating an electronic device 201 in a communication network by using a subscriber identification module (SIM) 224 (e.g., a SIM card). According to an embodiment, the cellular module 221 is capable of performing at least part of the functions provided by the processor 210. According to an embodiment, the cellular module 172I is also capable of including a communication processor (CP).

Each of the WiFi module 223, the BT module 225, the GNSS module 227, and the NFC module 228 is capable of including a processor for processing data transmitted or received through the corresponding module. According to embodiments, at least part of the cellular module 221, WiFi module 223, BT module 225, GNSS module 227, and NFC module 228 (e.g., two or more modules) may be included in one integrated chip (IC) or one IC package.

The RF module 229 is capable of transmission/reception of communication signals, e.g., RF signals. The RF module 229 is capable of including a transceiver, a power amp module (PAM), a frequency filter, a low noise amplifier (LNA), an antenna, etc. According to another embodiment, at least one of the following modules: cellular module 221, WiFi module 223, BT module 225, GNSS module 227, and NFC module 228 is capable of transmission/reception of RF signals through a separate RF module.

The SIM module 224 is capable of including a card including a SIM and/or an embodied SIM. The SIM module 224 is also capable of containing unique identification information, e.g., integrated circuit card identifier (ICCID), or subscriber information, e.g., international mobile subscriber identity (IMSI).

The memory 230 (e.g., memory 130 shown in FIG. 1) is capable of including a built-in or internal memory 232 or an external memory 234. The built-in memory 232 is capable of including at least one of the following: a volatile memory, e.g., a dynamic random access memory (DRAM), a static RAM (SRAM), a synchronous dynamic RAM (SDRAM), etc.; and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 234 is also capable of including a flash drive, e.g., a compact flash (CF), a secure digital (SD), a micro secure digital (Micro-SD), a mini secure digital (Mini-SD), an extreme digital (xD), a multi-media card (MMC), a memory stick, etc. The external memory 234 is capable of being connected to the electronic device 201, functionally and/or physically, through various interfaces.

The sensor module 240 is capable of measuring/detecting a physical quantity or an operation state of the electronic device 201, and converting the measured or detected information into an electronic signal. The sensor module 240 is capable of including at least one of the following: a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and a ultraviolet (UV) sensor 240M. Additionally or alternatively, the sensor module 240 is capable of further including an olfactory sensor or electronic nose (E-nose) sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 is capable of further including a control circuit for controlling one or more sensors included therein. In embodiments, the electronic device 201 is capable of including a processor, configured as part of the processor 210 or a separate component, for controlling the sensor module 240. In this case, while the processor 210 is operating in sleep mode, the processor is capable of controlling the sensor module 240.

The input device 250 is capable of including a touch panel 252, a digital stylus or (digital) pen sensor 254, a key 256, or an ultrasonic input unit 258. The touch panel 252 may be implemented with at least one of the following: a capacitive touch system, a resistive touch system, an infrared (IR) touch system, and an ultrasonic touch system. The touch panel 252 may further include a control circuit. The touch panel 252 may also further include a tactile layer to provide a tactile response to the user.

The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display 260 (e.g., the display 160 shown in FIG. 1) is capable of including a panel 262, a hologram unit 264, or a projector 266. The panel 262 may include the same or similar configurations as the display 160 shown in FIG. 1. The panel 262 may be implemented to be flexible, transparent, or wearable. The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. According to an embodiment, the display 260 may further include a control circuit for controlling the panel 262, the hologram unit 264, or the projector 266.

The interface 270 is capable of including a high-definition multimedia interface (HDMI) 272, a universal serial bus (USB) 274, an optical interface 276, or a D-subminiature (D-sub) 278. The interface 270 may be included in the communication interface 170 shown in FIG. 1. Additionally or alternatively, the interface 270 is capable of including a mobile high-definition link (MHL) interface, a secure digital (SD) card/multimedia card (MMC) interface, or an infrared (IR) data association (IrDA) standard interface.

The audio module 280 is capable of providing bidirectional conversion between a sound and an electronic signal. At least part of the components in the audio module 280 may be included in the input/output interface 150 shown in FIG. 1. The audio module 280 is capable of processing sound information input or output through a speaker 282, a receiver 284, earphones 286, microphone 288, etc.

The camera module 291 refers to a device capable of taking both still and moving images. According to an embodiment, the camera module 291 is capable of including one or more image sensors (e.g., a front image sensor or a rear image sensor), a lens, an image signal processor (ISP), a flash (e.g., an LED or xenon lamp), etc.

The power management module 295 is capable of managing power of the electronic device 201. According to an embodiment, the power management module 295 is capable of including a power management integrated circuit (PMIC), a charger IC, or a battery or fuel gauge. The PMIC may employ wired charging and/or wireless charging methods. Examples of the wireless charging method are magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual capacity, charge in voltage, current, or temperature of the battery 296. The battery 296 takes the form of either a rechargeable battery or a solar battery.

The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. Although not shown, the electronic device 201 is capable of further including a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™, etc.

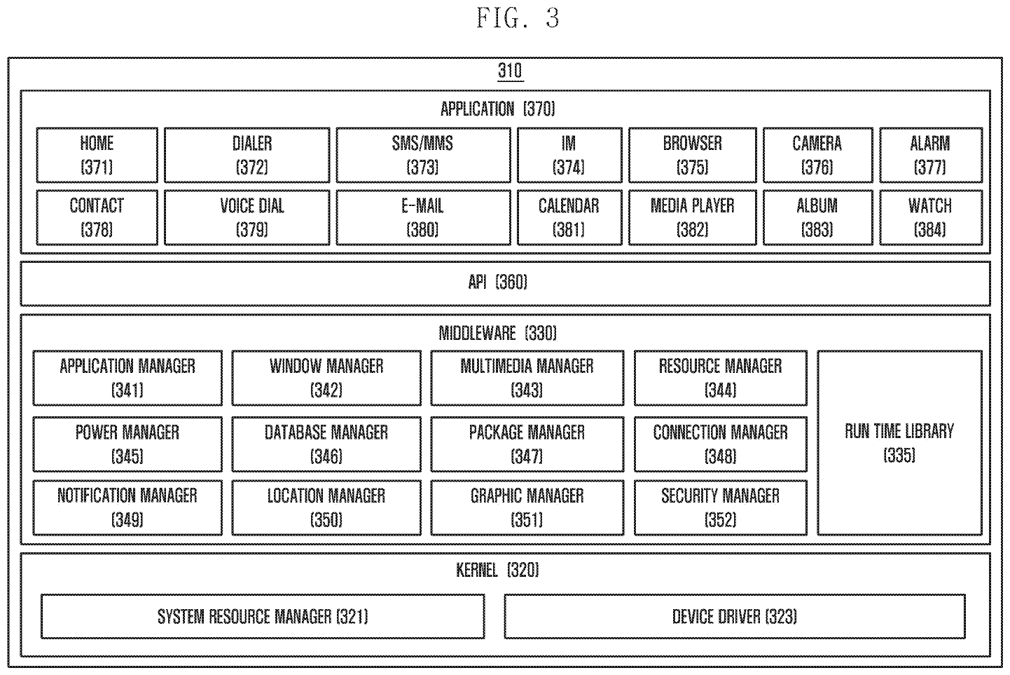

FIG. 3 is a block diagram of a programming module according to various embodiments of the present disclosure. According to an embodiment, the program module 310 (e.g., program module 140 shown in FIG. 1) is capable of including an operation system (OS) for controlling resources related to the electronic device (e.g., electronic device 101) and/or various applications (e.g., application programs 147 shown in FIG. 1) running on the OS. The OS may be Android™, iOS™, Windows™, Symbian®, Tizen®, Bala®, etc.

Referring to FIG. 3, the program module 310 is capable of including a kernel 320, middleware 330, application programming interface (API) 360 and/or applications 370. At least part of the program module 310 may be preloaded on the electronic device or downloaded from a server (e.g., an electronic device 102 or 104, server 106, etc.).

The kernel 320 (for example, kernel 141) may include a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth (BT) driver, a shared memory driver, a USB driver, a keypad driver, a WiFi driver, and an audio driver. Further, according to an embodiment, the device driver 323 may include an inter-process communication (IPC) driver.

The middleware 330 may provide a function required in common by the applications 370. Further, the middleware 330 may provide a function through the API 360 to allow the applications 370 to efficiently use limited system resources within the electronic device. According to an embodiment, the middleware 330 (for example, the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352.

The runtime library 335 may include, for example, a library module used by a complier to add a new function through a programming language while the applications 370 are executed. According to an embodiment, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a basic input/output system (BIOS) to manage a battery or power and provides power information required for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as WiFi or BT. The notification manager 349 may display or notify a user of an event such as an arrival message, an appointment, a proximity alarm or the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment, when the electronic device (for example, the electronic device 101) has a call function, the middleware 330 may further include a telephony manager for managing a voice of the electronic device or a video call function.

The middleware 330 is capable of including modules configuring various combinations of functions of the above described components. The middleware 330 is capable of providing modules specialized according to types of operation systems to provide distinct functions. The middleware 330 may be adaptively configured in such a way as to remove part of the existing components or to include new components.

The API 360 (for example, API 145 shown in FIG. 1) may be a set of API programming functions, and may be provided with a different configuration according to an operating system. For example, in Android™ or iOS™, a single API set may be provided for each platform. In Tizen®, two or more API sets may be provided.

The applications 370 (e.g., application programs 147) may include one or more applications for performing various functions, e.g., home 371, diary 372, SMS/multi-media message service (MMS) 373, instant message (IM) 374, browser 375, camera 376, alarm 377, contact 378, voice dial 379, email 380, calendar 381, media player 382, album 383, clock 384, health care (e.g., an application for measuring amount of exercise, blood sugar level, etc.), and environment information (e.g., an application for providing atmospheric pressure, humidity, temperature, etc.).

According to an embodiment, the applications 370 are capable of including an application for supporting information exchange between an electronic device (e.g., electronic device 101) and an external device (e.g., electronic devices 102 and 104), which is hereafter called ‘information exchange application’). The information exchange application is capable of including a notification relay application for relaying specific information to external devices or a device management application for managing external devices.

For example, the notification relay application is capable of including a function for relaying notification information, created in other applications of the electronic device (e.g., SMS/MMS application, email application, health care application, environment information application, etc.) to external devices (e.g., electronic devices 102 and 104 shown in FIG. 1). In addition, the notification relay application is capable of receiving notification information from external devices to provide the received information to the user.

The device management application is capable of managing (e.g., installing, removing or updating) at least one function of an external device (e.g., electronic devices 102 and 104) communicating with the electronic device. Examples of the function are a function of turning-on/off the external device or part of the external device, a function of controlling the brightness (or resolution) of the display, applications running on the external device, services provided by the external device, etc. Examples of the services are a call service, messaging service, etc.

According to an embodiment, the applications 370 are capable of including an application (e.g., a health care application of a mobile medical device, etc.) specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third party applications that can be downloaded from a server. It should be understood that the components of the program module 310 may be called different names according to types of operating systems.

According to various embodiments, at least part of the program module 310 can be implemented with software, firmware, hardware, or any combination of two or more of them. At least part of the program module 310 can be implemented (e.g., executed) by a processor (e.g., processor 210 shown in FIG. 2). At least part of the programming module 310 may include modules, programs, routines, sets of instructions or processes, etc., in order to perform one or more functions.

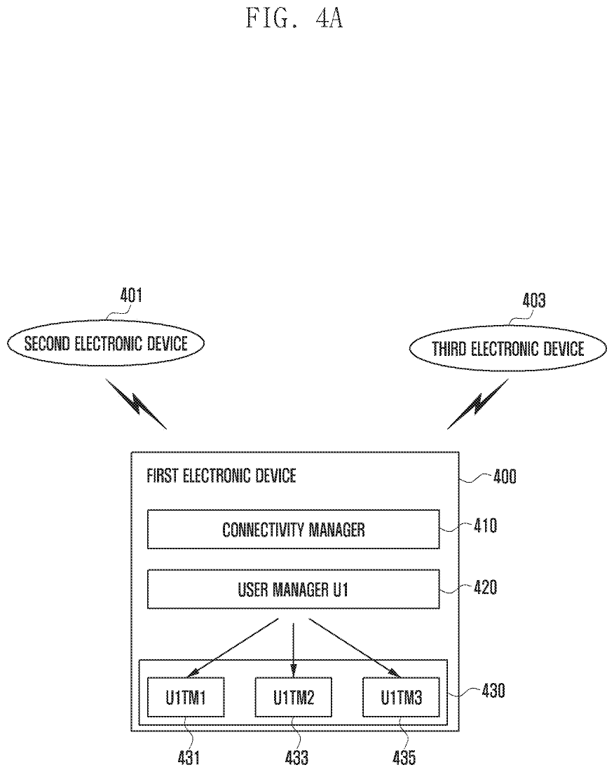

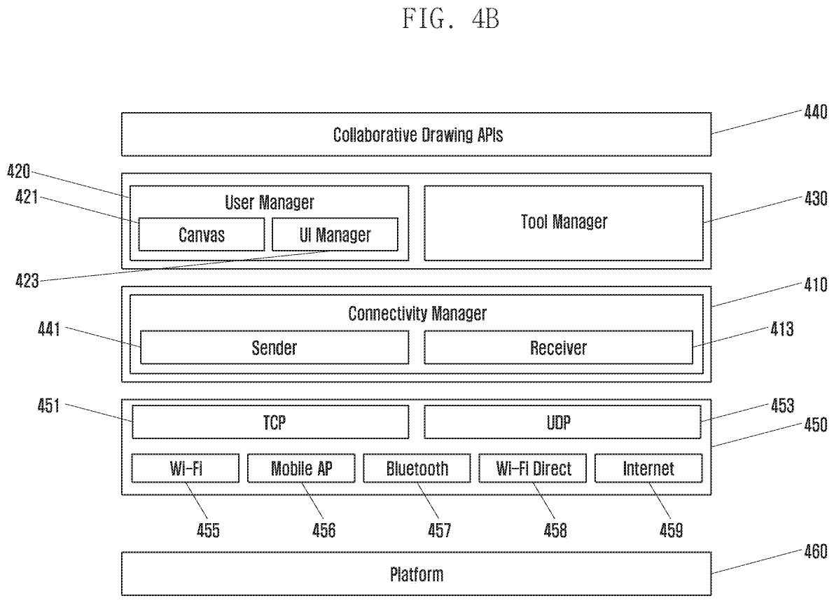

FIGS. 4A and 4B are diagrams for explaining a procedure for establishing a collaborative drawing session among multiple electronic devices according to various embodiments of the present disclosure.

Referring to FIG. 4A, the first electronic device 400 (e.g., the electronic device 201 of FIG. 2) may include a connectivity manager 410 (connectivity management module), a user manager 420 (U1, user management module), and at least one tool manager 430 (e.g., first electronic device tool manager (User1 Tool Manager1 (U1TM1)) 431, User1 Tool Manager2 (U1TM2) 433, and User1 Tool Manager3 (U1TM3) 435). For convenience of explanation, the electronic devices are referred to respectively as a first electronic device 400, a second electronic device 401, and a third electronic device 403 in FIG. 4A. The first electronic device 400 may be identical with the electronic device 201 of FIG. 2. The first electronic device 400 may connect to the second and third electronic devices 401 and 403. For example, assuming that the first to third electronic devices 400, 401, and 403 connect to each other via a drawing application, they may join in a group/channel. If the first to third electronic devices 400, 401, and 403 join in a group/channel, this means that they connect to each other. The connectivity manager 410, the user manager 420, and the tool manager 430 may be structurally included in an application processor 210 (hereinafter referred to as a processor) of the electronic device 201 (shown in FIG. 2). These managers may be stored in the memory 230 of the electronic device 201 or configured differently in the electronic device 201.

The connectivity manager 410 may check network connectivity of the first electronic device 400. The connectivity manager 410 may check whether the first electronic device 400 has connected to the second and third electronic devices 401 and 403 via the drawing application. The connectivity manager 410 may control the first electronic device 400 to maintain the connections to the second and third electronic devices 401 and 403. The connectivity manager 410 may establish the connections to the second and third electronic devices 403 over at least one of Wireless Fidelity (Wi-Fi), Wi-Fi-direct, application, BT, and internet protocol (IP). The connectivity manager 410 may establish the connection to other electronic devices with or without assistance of a server. The connectivity manager 410 may provide the first electronic device 400 with the information on the connectivity to the second and third electronic devices 401 and 403 and data communication with the second and third electronic devices 401 and 403.

For example, with reference to FIGS. 4A and 4B, the processor 210 of the first electronic device 400 may establish a drawing application-based group/channel for communication with the second and third electronic devices 401 and 403. The processor 210 may manage the electronic devices that are joining in and disjoining from the group/channel by means of the connectivity manager 410. If there are other electronic devices that are joining in the group/channel, the connectivity manager 410 may provide the joined electronic devices with the information concerning the joining of the other electronic devices. If there are other electronic devices that are disjoining from the group/channel, the connectivity manager 410 may provide the joined electronic devices with the information concerning the disjoining of the other electronic devices. If an event occurs at one of the electronic devices joined in the group/channel, the connectivity manager 410 may provide all of the electronic devices joined in the group/channel with the information on the event. That is, the connectivity manager 410 may control such that all of the electronic devices joined in the group/channel share the same picture drawing information.

The user manager 420 may manage the information on the second and third electronic devices 410 and 403 connected to the first electronic device 400. The user manager 420 may generate the U1TM1 corresponding to the first electronic device 400 and then the U1TM2 433 and U1TM3 435 based on the information received from the second and third electronic devices 401 and 403.

For example, the second electronic device 401 may be in the state that its drawing application is configured based on the picture drawing information (e.g., brush information). The third electronic device 403 may also be in the state that its drawing application is configured based on the picture drawing information. Here, the first electronic device 400 may receive the picture drawing information from the second and third electronic devices 401 and 403 respectively. The user manager 420 may generate the U1TM2 433 based on the picture drawing information received from the second electronic device 401 and the U1TM3 based on the picture drawing information received from the third electronic device 403. The user manager 420 of the first electronic device 400 may check the connectivity of other electronic devices connected to the first electronic device 400 and generate tool managers corresponding to the connected electronic devices. If the electronic device to which the corresponding tool manager has been generated is disconnected, the user manager 420 may delete the corresponding tool manager. According to various embodiments, the user manager 420 of the first electronic device 400 may receive the picture drawing information from the second and third electronic devices 401 and 403 connected to the first electronic device 400 and generate the U1TM2 433 corresponding to the second electronic device 401 and the U1TM3 435 corresponding to the third electronic device 403.

Referring to FIGS. 4A and 4B, typically, each tool manager is generated for each of the respective electronic devices, i.e., the first electronic device 400 and the second and third electronic devices 401 and 403 connected to the first electronic device 400. Although not shown, the second electronic device 401 may also generate the tool manager of the second electronic device 401 and the tool managers of the first and third electronic devices 400 and 403 connected to the second electronic device 401. The electronic devices may generate their own tool managers by themselves. The tool manager 430 may include brush information corresponding to other electronic devices. For example, the user manager 420 of the first electronic device 400 may generate the U1TM1 431 based on the drawing application. The U1TM1 may include the picture drawing information preconfigured in the first electronic device 400. The user manager 420 of the first electronic device 400 may generate the U1TM2 corresponding to the second electronic device 401 connected to the first electronic device 400 and the U1TM3 corresponding to the third electronic device 403 connected to the first electronic device 400. The U1TM2 may include the picture drawing information preconfigured in the second electronic device 401, and the U1TM3 may include the picture drawing information preconfigured in the third electronic device 403. Here, the picture drawing information may be the information on the tool for use in drawing a picture. For example, the picture drawing information may include the properties of the brush such as type and color of the brush.

That is, if the first and second electronic devices 400 and 401 have connected to each other via the drawing application, the first electronic device 400 may generate a first electronic device-first electronic device tool manager corresponding to the first electronic device 400. The first electronic device 400 may also generate a first electronic device-second electronic device tool manager 433 corresponding to the second electronic device 401 connected to the first electronic device. Meanwhile, the second electronic device 401 may also generate a second electronic device-second electronic device tool manager corresponding to the second electronic device 401 and a second electronic device-first electronic device tool manager corresponding to the first electronic device 401. That is, the electronic devices may generate the tool managers by themselves. Here, the tool managers may be categorized into one of a self-manager and a tool manager corresponding to another electronic device connected to the current electronic device.

According to various embodiments of the present disclosure, the first electronic device 400 may maintain the connections to the second and third electronic devices 401 and 403 via the drawing application and receive the picture drawing information from the second and third electronic devices 401 and 403. The electronic devices may receive the picture drawing information of the other electronic devices connected thereto.

FIG. 4B is a block diagram illustrating configurations of the connectivity manager, user manager, and tool manager of FIG. 4A. Referring to FIG. 4B, the first electronic device 400 (electronic device 201 of FIG. 2) may include a connectivity manager 410, a user manager 420, a tool manager 430, collaborative drawing APIs 440, a communication module 450 (communication module 220 of FIG. 2), and a platform 460.

The connectivity manager 410 has been described in detail with reference to FIG. 4A, and the first electronic device 400 may maintain the connections to other electronic devices. The connectivity manager 410 may control a sender 441 and a receiver 413 (shown in FIG. 4B). The connectivity manager 410 may transmit data to the connected electronic devices by means of the sender 441 and receive data from the connected electronic devices by means of the receiver 413.

The user manager 420 has been described in detail with reference to FIG. 4A, and the first electronic device 400 may manage the connected electronic devices. The user manager 420 may manage a canvas 421 and a manager (U1 manager) 423 corresponding to the first electronic device 400. Here, the canvas 420 may be displayed on the screen of the electronic device (display module 260 shown in FIG. 2) along with the information received from other electronic devices.

The tool manager 430 has been described in detail with reference to FIG. 4A. The tool manager 430 may include a plurality of tool managers. For example, the tool manager 403 may include the first electronic device-first electronic device tool manager corresponding to the first electronic device 400 and the first electronic device-second electronic device tool manager corresponding to the second electronic device connected to the first electronic device.

The collaborative drawing APIs 440 may be included in the application programming interface (API) 145 of FIG. 1 and may make it possible to display the user interface of the drawing application.

The communication module 450 may be identical with the communication module 220 shown in FIG. 2 and may include a module for communication with other electronic devices. The communication module 450 may include a transmission control protocol (TCP) module 451, a user datagram protocol (UDP) module 453, a Wi-Fi module 455, a mobile AP module 456, a BT module 457, a Wi-Fi direct module 458, and an Internet module 459 for establishing connections with other electronic devices. The first electronic device 400 may connect to other electronic devices by means of the communication module 450 with or without assistance of a server.

The platform 460 may include computer architecture, Operating Systems (OS), programming languages, libraries, and graphical user interfaces (GUIs). The first electronic device 400 may perform the above-described operations on the platform 460.

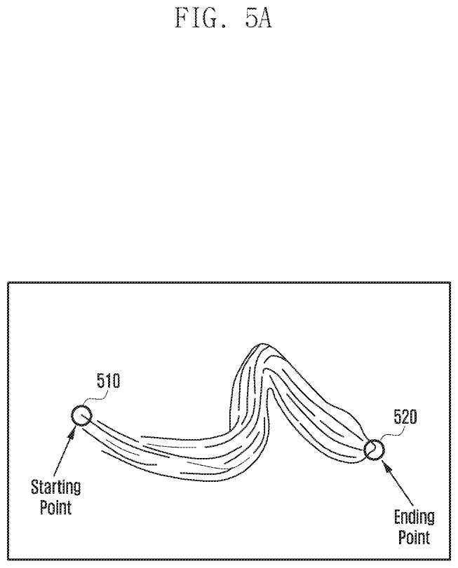

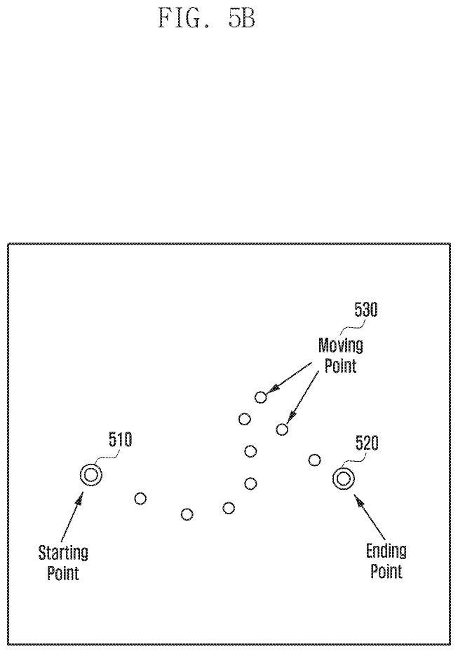

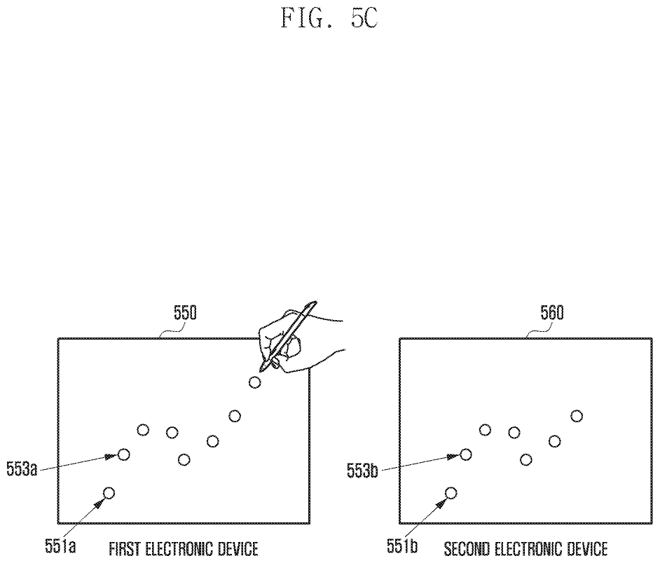

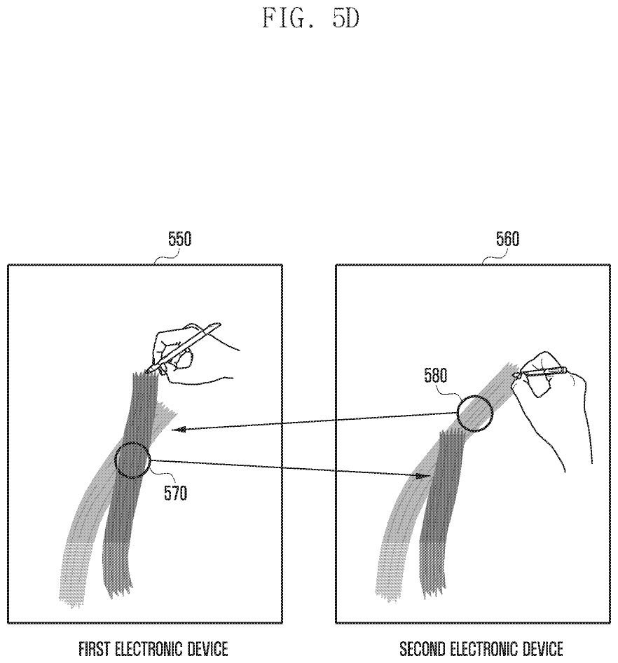

FIGS. 5A to 5D are diagrams illustrating various screen displays for explaining how to draw pictures collaboratively according to various embodiments of the present disclosure.

Referring to FIG. 5A, the processor 210 of the electronic device 201 (shown in FIG. 2) may draw a picture based on the user input. At this time, the drawing application may be running on the electronic device 201. If the user makes a touch input on the screen, the processor 210 may check a starting point 510 and an ending point 520 of the touch input. The processor 210 may interpret the detection of the starting point of the touch input as occurrence of a start event and the detection of the ending point of the touch input as occurrence of an end event.

Referring to FIG. 5B, the processor 210 may detect at least one moving point 530, as well as the starting point 510 and the ending point 520 during the drawing process (i.e., during the touch input). It may be possible to check the moving point 530 at a predetermined interval or at a predetermined moving distance. It may be possible to determine the moving point 530 when the movement direction changes during the drawing process. It may also be possible to determine the moving point 530 when accumulative user input data reaches a predetermined data size. If a user input corresponding to the moving point 530 is detected, the processor 210 interprets the user input as occurrence of a moving event. For example, the processor 210 may check the occurrence of one start event and a plurality of moving events during the drawing process. The processor 210 may detect the occurrence of the end event. Although a specific number of moving points 530 are depicted in FIG. 5B, the number of moving points is not limited thereto.

FIG. 5C shows various screen displays of the electronic device in the state that the first and second electronic devices 550 and 560 have connected to each other via the drawing application. With reference to FIG. 5C, the first electronic device 550 may be in the state that the user draws a picture. The first electronic device 550 may detect a start event generated by the user and recognize the corresponding point as a first starting point 551a. Here, the start event may be detected when an event occurrence condition is fulfilled. For example, the start event occurrence condition may be fulfilled when the user input is detected first in the canvas displayed on the screen. That is, if the user input is detected first on the canvas, the first electronic device 550 detects the occurrence of the start event. The first electronic device 550 may send the second electronic device 560 the information on the recognized first starting point 551a. The second electronic device 560 may display, on its screen, a second starting point 551b that is determined based on the information concerning the first starting point 551a that has been transmitted by the first electronic device 550. The coordinates of the first starting point 551a displayed on the first electronic device 550 may be identical with the coordinates of the second starting point 551b displayed on the second electronic device. Although not shown, the first and second electronic devices 550 and 560 may exchange the information on the tools selected at the respective electronic devices while being connected. That is, the first and second electronic devices 550 and 560 may check the tools selected by each other before the occurrence of the starting event.

Referring to FIG. 5C, during the picture drawing process, the first electronic device 550 may detect a moving event and recognize the moving event as a first moving point 553a. Here, the moving event is detected when a predetermined event occurrence condition is fulfilled. For example, the moving event occurrence condition may be fulfilled when the user input moves (is dragged) as long as a predetermined distance, a predetermined time period elapses after the start of the user input, or accumulative user input data reaches a predetermined data amount. The moving event occurrence condition may also be fulfilled when the movement direction of the user input is changed. That is, first electronic device 550 may detect occurrence of a moving event based on the predetermined event occurrence condition. The first electronic device 550 may send the second electronic device 560 the information on the first moving point 553a. The second electronic device 560 may display the second moving point 553b on its screen based on the information on the first moving point 553a that is transmitted by the first electronic device 550. Like the starting point, the coordinates of the first moving point 553a displayed on the first electronic device may be identical with the coordinates of the second moving point 553b displayed on the second electronic device 560.

Referring to FIG. 5C, the last one of the moving points recognized by the first electronic device 550 is not reflected yet on the screen of the second electronic device 560. The first electronic device 550 may transmit the coordinates corresponding to the moving event that has occurred already, and the second electronic device 560 may display the moving event on its screen based on the received coordinates. That is, the screens of the first and second electronic devices 550 and 560 are identical with each other. Although FIG. 5C shows a procedure in which the first electronic device 550 detects a predetermined event and transmits the information on the event to the second electronic device 560, the present disclosure is not limited to the specific procedure. Whenever a predetermined event (e.g., start event, moving event, and end event) occurs, the first electronic device 550 transmits the information on the corresponding event to the second electronic device 560, thereby making it possible to display the information corresponding to the same event on the screens of the first and second electronic devices 550 and 560 almost simultaneously.

FIG. 5D illustrates a situation in which picture drawing actions are made at the first and second electronic devices 550 and 560 that are connected via the drawing application. In FIG. 5D, the left part may show the screen display of the first electronic device 550, and the right part may show the screen display of the second electronic device 560. The user of the first electronic device 550 may draw the picture using the first electronic device 550, and the user of the second electronic device 560 may draw the picture using the second electronic device 560.

While the user of the first electronic device 550 draws the picture, the first electronic device 550 may be in the state of having recognized the first moving event 570. The first electronic device 550 may transmit the information on the first moving event 570 to the second electronic device 560. The second electronic device 560 may display the drawing result inclusive of the first moving event 570 recognized by the first electronic device 550. Since no other event is detected yet after the detection of the first moving event 570 even though the user continues drawing the picture, the second electronic device 560 may display the drawing result till the first moving event 570.

Meanwhile, while the user of the second electronic device 560 is drawing the picture, the second electronic device 560 may recognize the second moving event 580 and continue drawing the picture. The second electronic device 560 may transmit the information on the second moving event 580 to the first electronic device 550. The first electronic device 550 may display the drawing result till the second moving event 580 in correspondence to the picture drawing operation at the second electronic device 560.

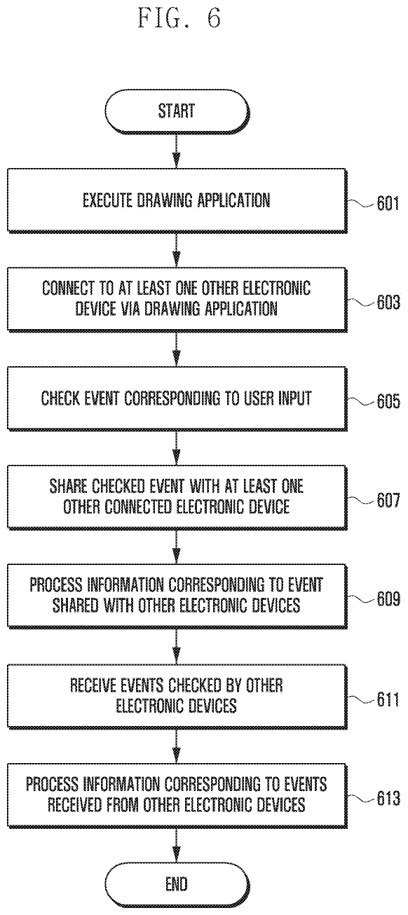

FIG. 6 is a flowchart illustrating a collaborative drawing method according to various embodiments of the present disclosure.

Referring to FIG. 6, the processor 210 of the electronic device 201 (shown in FIG. 2) may execute a drawing application at operation 601. The drawing application may be an application capable of receiving the user input (hand touch, pen touch, hand hovering, and pen hovering) and drawing a picture according to the user input. The drawing application may generate a group/channel according to a user input and allow the users of the electronic devices joined in the group/channel to draw a picture on one canvas collaboratively.

The processor 210 may connect to at least one other electronic device on which the drawing application is running at operation 603. Although not shown, the processor 210 may generate a group/channel by means of the drawing application to connect to other electronic devices. The other electronic devices may join in the group/channel. The electronic devices joined in the same group/channel may be in the state of being connected to each other. The processor 210 may control the electronic device to share the picture drawing information with the other connected electronic devices. Here, the picture drawing information may include the information on the tool (e.g., brush) for use in drawing the picture. That is, the processor 210 may control the electronic device to share the drawing application information with other connected electronic devices.

The processor 210 may detect an event corresponding to the user input at operation 605. The processor 210 may receive a user input through the input device 250 and detect an event concerning the user input. The event may be a start event, a moving event, or an end event. The event occurrence conditions may be preconfigured, and the processor 210 may detect an event based on the predetermined event occurrence conditions. For example, the start event may be detected when a user input starts on the canvas displayed on the screen. The moving event may be detected when the user input moves (is dragged) as long as a predetermined distance, a predetermined time period elapses after the start of the user input, or accumulative user input data reaches a predetermined data amount. Also, the moving event may be detected when the movement direction of the user input is changed. The end event may be detected when the user input ends. If the user input ends, this may denote that the user has made a complete stroke. The event occurrence conditions may include conditions related to the drawing tools as well as the conditions related to the start event, moving event, and end event.

Here, the event may be an event in which the picture drawing information is changed. Here, the picture drawing information may be the information concerning the tool (e.g., brush) for use in drawing a picture. For example, the picture drawing information may include the information on the brush selected first when the drawing application is executed in the first electronic device (e.g., type, boldness, and color of the brush) and, when the brush is changed, the information on the changed brush. The processor 210 may transmit the information corresponding to the detected event to other electronic devices at operation 605. For example, if a start event, a moving event, or an end event is detected, the processor may transmit the coordinates corresponding to the detected event to other electronic devices. Since the picture drawing information is transmitted when the electronic device connects to another electronic device, the processor 210 may transmit only the essential information (e.g., user input coordinates) corresponding to the detected event to the other electronic device. If a picture drawing information change event is detected, the processor 210 may transmit the information concerning only the change of the picture drawing information.

The processor 210 may share the detected event with the other connected electronic devices at operation 607. For example, if the start event is detected, the processor may provide the other connected electronic devices with the information on the event in real time. According to various embodiments, whenever an event is detected, the electronic device may share the information on the event with other electronic devices in real time.

The processor 210 may process the information on the event shared with other electronic devices in real time at operation 609. For example, the first electronic device may display the information shared with other electronic devices joined in the same group on its screen. The second electronic device may display the information shared with other electronic devices joined in the same group on its screen. That is, if the first and second electronic devices have joined in the same group, the information displayed on the screens of the first and second electronic devices may be identical with each other.

The processor 210 may receive an event detected by another electronic device at operation 611. The processor 210 may process the event information receive from other electronic devices at operation 613. That is, the processor 210 may process the events received from other electronic devices along with the detected event. Operations 605 to 613 may be performed in a different order and simultaneously.

According to various embodiments of the present disclosure, if an electronic device has connected to other electronic devices via a drawing application, it may be possible to share the picture drawing information with the electronic devices. If an event is detected based on the event occurrence conditions corresponding to a user input, the electronic device may share the information corresponding to the detected event with the exception of the previously shared picture drawing information. According to various embodiments, the electronic device may perform data sharing by transmitting data relatively small in size, thereby achieving real-time operation and making it possible to process information more quickly. That is, the present disclosure may accomplish a visual effect of showing the same screen on the electronic devices joined in a group.

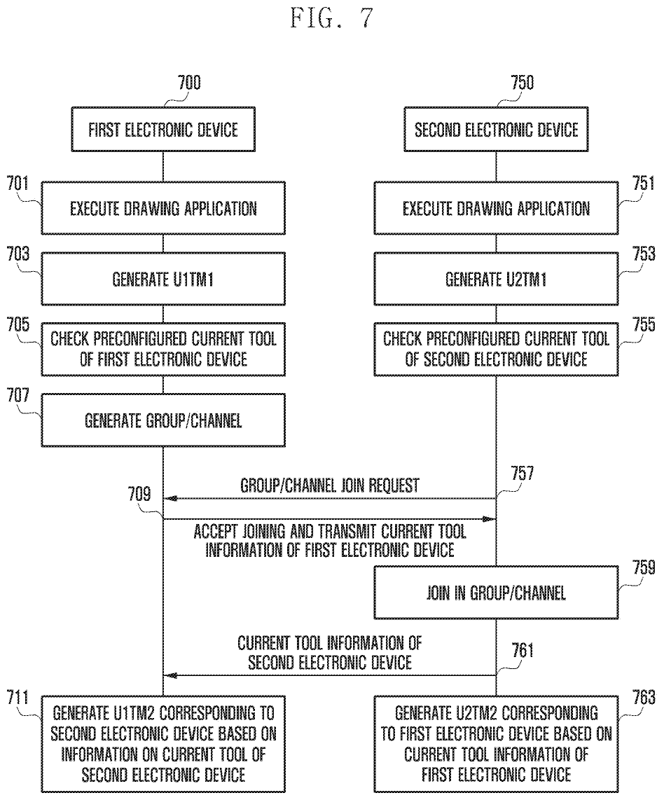

FIG. 7 is a flowchart illustrating a procedure of establishing a connection between electronic devices for drawing a picture collaboratively according to an embodiment of the present disclosure.

Referring to FIG. 7, the operations of the first electronic device 700 and the second electronic device 750. At operation 701, the first electronic device 700 may execute a drawing application. At operation 703, the first electronic device 700 may generate the first electronic device tool manager (U1TM1). The U1TM1 may manage the tool information of the first electronic device 700. At operation 705, the first electronic device 700 may check the current tool (brush) preconfigured for use in the first electronic device 700. The current tool of the first electronic device 700 may be preconfigured without limitation in any way. At operation 707, the first electronic device 700 may generate a group/channel for connection to another electronic device (e.g., second electronic device 750).

Similar to the operation of the first electronic device 700, the second electronic device 750 may execute the drawing application at operation 751. At operation 753, the second electronic device 750 may generate the second electronic device tool manager (U2TM1). The U2TM1 may manage the tool information of the second electronic device 750. At operation 755, the second electronic device 750 may check the current tool (brush) preconfigured for use in the second electronic device 750. The second electronic device 750 may transmit a signal requesting for joining in the group/channel generated by the first electronic device 700.

At operation 757, the second electronic device 750 may transmit a join request signal to the first electronic device 700 to request for joining in the established group/channel. At operation 709, the first electronic device 700 may accept the joining of the second electronic device 750 and transmit the tool information of the current electronic device 700 to the second electronic device 750 in response to the joining request. At operation 759, the second electronic device 750 may join the group/channel. At operation 761, the second electronic device 750 may transmit the current tool information of the second electronic device to the first electronic device 700. At operation 711, the first electronic device 700 may generate the second electronic device tool manager (U1TM2) corresponding to the second electronic device 750 based on the current tool information of the second electronic device 750. Like the first electronic device 700, the second electronic device 750 may generate the first electronic device tool manager (U2TM2) corresponding to the first electronic device 700 based on the current tool information of the first electronic device 700 at operation 763.

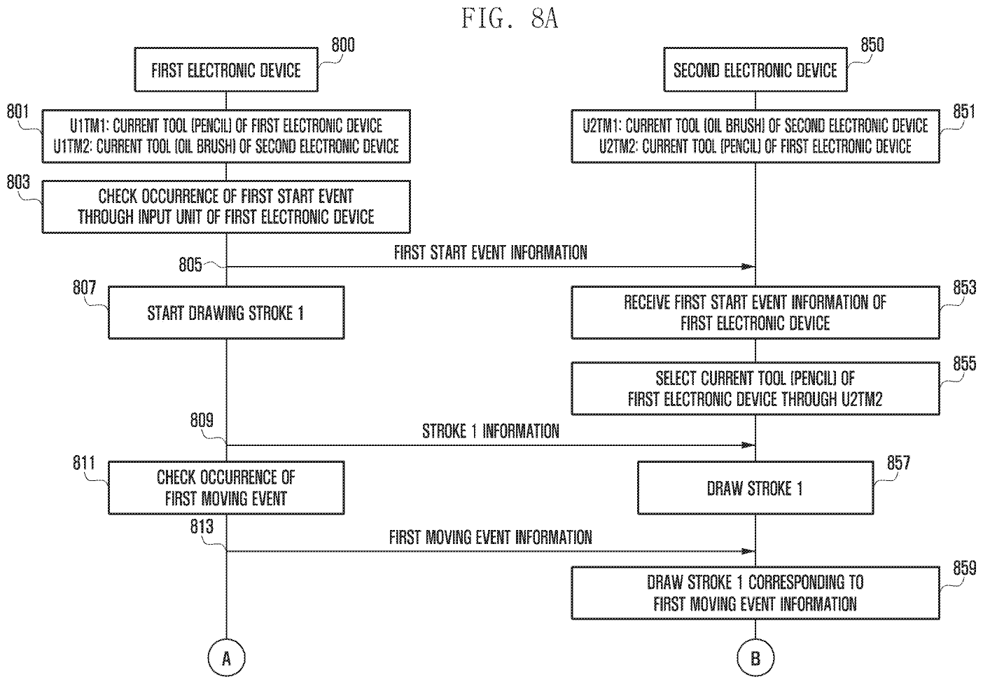

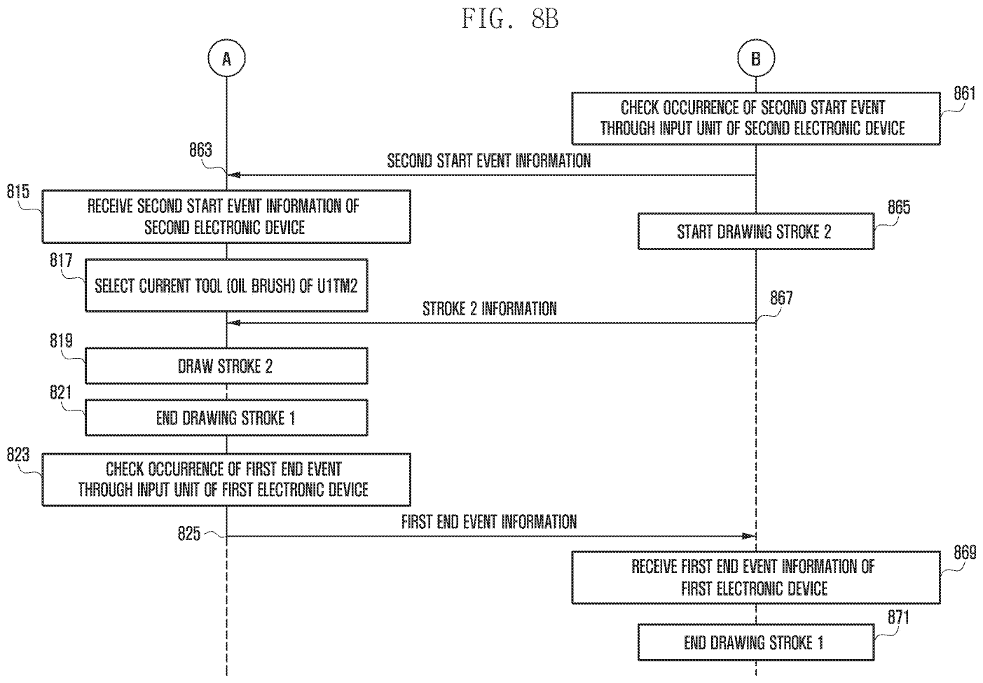

FIGS. 8A and 8B are a flowchart illustrating a collaborative drawing procedure according to various embodiments of the present disclosure.

FIGS. 8A and 8B show the operations of the first and second electronic devices 800 and 850. The first and second electronic devices 800 and 850 may be in the state of running a drawing application, of having joined in the same group/channel via the drawing application, and of sharing current tool information thereof.

At operation 801, the first electronic device 800 may check that the current tools of the first and second electronic devices 800 and 850 are a pencil and an oil brush, respectively. The first electronic device 800 may generate a first electronic device tool manager (U1TM1) and a second electronic device tool manager (U1TM2). At operation 851, the second electronic device 850 may check that its current tool is the oil brush and the current tool of the first electronic device 800 is the pencil. The second electronic device 850 may generate a second electronic device tool manager (U2TM1) and a first electronic device tool manager (U2TM2).

At operation 803, the first electronic device 800 may check the occurrence of the first start event based on the user input made through an input unit of the first electronic device. The first start event may be detected when the user input (hand input, pen input, hand hover, and pen hover) starts on the canvas of the drawing application that is displayed on the first electronic device. At operation 805, the first electronic device 800 may send the second electronic device 850 the information on the first start event.

At operation 853, the second electronic device 850 may receive the first start event information from the first electronic device 800. At operation 855, the second electronic device 850 may select the current pencil of the first electronic device by means of the U2TM2.

At operation 807, the first electronic device 800 may draw stroke 1. The first electronic device 800 may draw the stroke 1 on the canvas provided by the drawing application. The stroke 1 may be the stroke starting with the first start event that occurred at operation 803 and lasting after the first start event. At operation 809, the first electronic device 800 may transmit the information on the stroke 1 information to the second electronic device 850. At operation 857, the second electronic device 850 may draw the stroke 1 on the canvas shared with the first electronic device 800. That is, the first and second electronic devices 800 and 850 may display the same canvas on their own screens via the drawing application.

At operation 811, the first electronic device 800 may check the occurrence of the first moving event. The first moving event may occur after a predetermined time period from the start of the user input or after the user input moves (is dragged) as long as a predetermined distance. The first moving event may occur when the movement direction of the user input has changed during the drawing process of stroke 1. At operation 813, the first electronic device 800 may transmit the first moving event information to the second electronic device 850.

The second electronic device 850 may receive the first moving event information from the first electronic device 800 and draw stroke 1 corresponding to the first moving event information at operation 859.

Referring to FIG. 8B, the second electronic device 850 may check the occurrence of the second start event based on the user input made by means of the input unit of the second electronic device 850 at operation 861. The second start event may occur when the user input (hand input, pen input, hand hover, and pen hover) starts on the canvas displayed on the second electronic device and shared with the first electronic device 800 via the drawing application. At operation 863, the second electronic device 850 may transmit the second start event information to the first electronic device 800.

At operation 815, the first electronic device 800 may receive the second start event information from the second electronic device 850. At operation 817, the first electronic device 800 may select the current tool (oil brush) of the second electronic device 850 by means of the U1TM2. Although not shown, if the current tool is changed in the second electronic device 850, the second electronic device 850 may detect a tool change event and transit tool change event information to the first electronic device 800. That is, the first electronic device 800 may identify the current tool of the second electronic device 850 correctly.

At operation 865, the second electronic device 850 may draw stroke 2. The second electronic device 850 may draw the stroke 2 on the canvas provided by the drawing application. That is, the second electronic device 850 may draw the stroke 2 on the canvas shared with the first electronic device 800 such that the first and second electronic devices 800 and 850 display the same picture.

At operation 867, the second electronic device 850 may transmit the stroke 2 information to the first electronic device 800. At operation 819, the first electronic device 800 may draw the stroke 2 on the canvas based on the stroke 2 information transmitted by the second electronic device 850. Although the stroke 2 may cause a second moving event, a detailed description thereof is omitted herein.

At operation 821, the first electronic device 800 may end drawing the stroke 1. That is, the first electronic device 800 may end drawing the stroke 1 to complete one stroke. At operation 823, the first electronic device 800 may check the occurrence of a first end event through the input unit of the first electronic device 800. If the release of the user input is detected through the input unit of the first electronic device 800, the first electronic device may recognize the occurrence of the first end event.

At operation 825, the first electronic device 800 may transmit the first end event information to the second electronic device 850. The second electronic device 850 may receive the first end event information from the first electronic device 800 at operation 869 and end drawing the stroke 1 at operation 871.

Since the operation related to stroke 2 is identical with the operation related to stork 1, a detailed description thereof is omitted. Although FIGS. 8A and 8B are directed to a case where two electronic devices exist, the number of electronic devices is not limited to any particular number. Although FIGS. 8A and 8B are directed to the case of drawing stroke 1 and stroke 2, the drawing action is not limited in any way. According to various embodiments of the present disclosure, a plurality of electronic devices connected via a drawing application may share one canvas. The plurality of electronic devices may display the same canvas that presents a picture being drawn collaboratively in real time. The plurality of electronic devices may share the events (e.g., start events, moving events, and end events) occurring at the individual electronic devices in real time. Accordingly, the users of electronic devices may participate in drawing the same picture on one shared canvas.

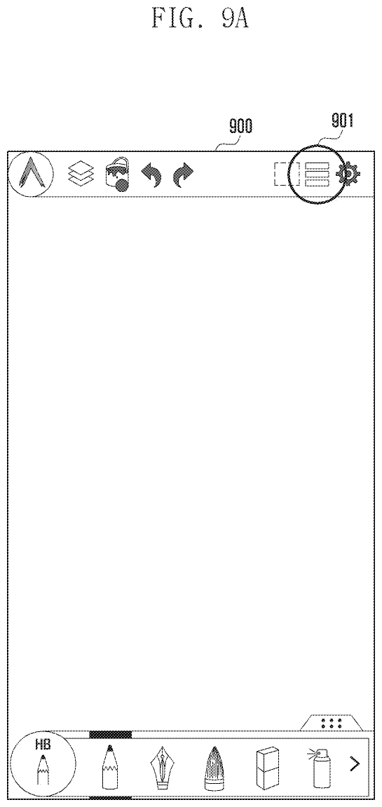

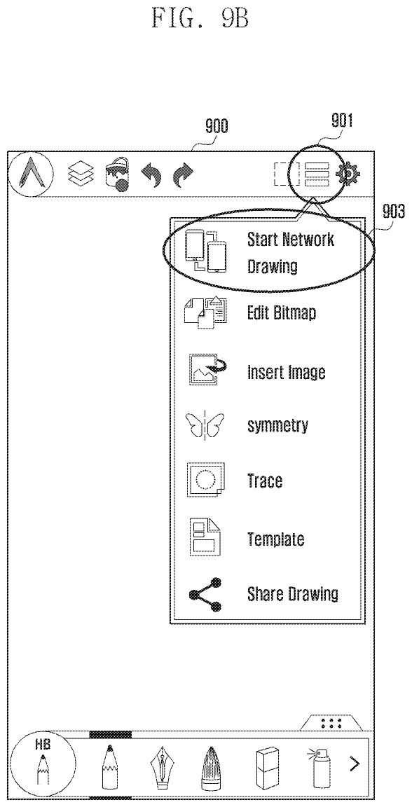

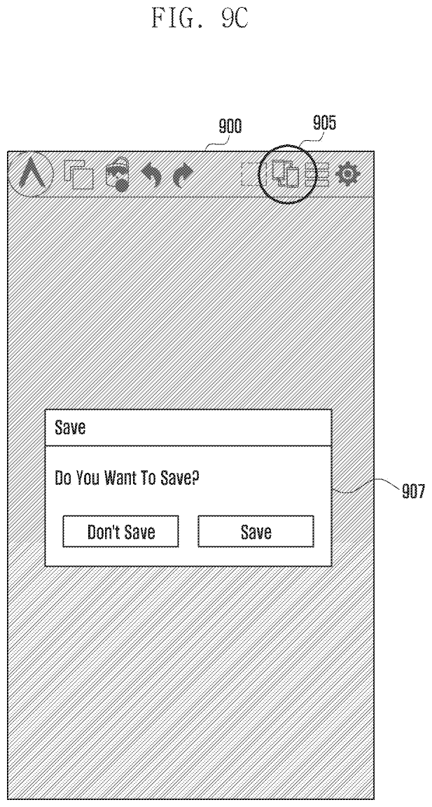

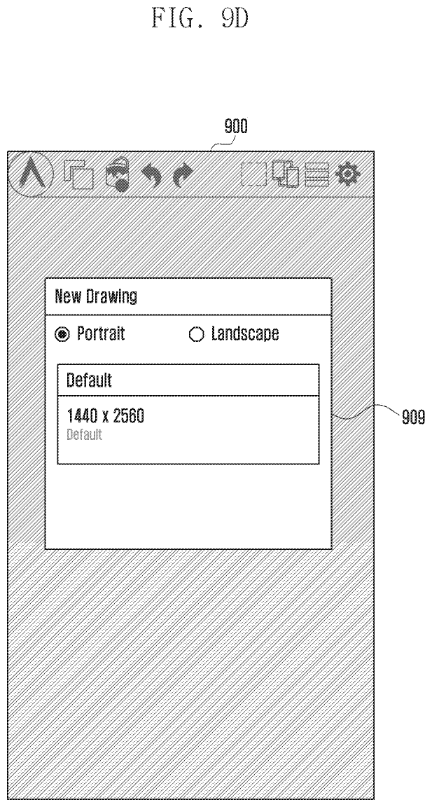

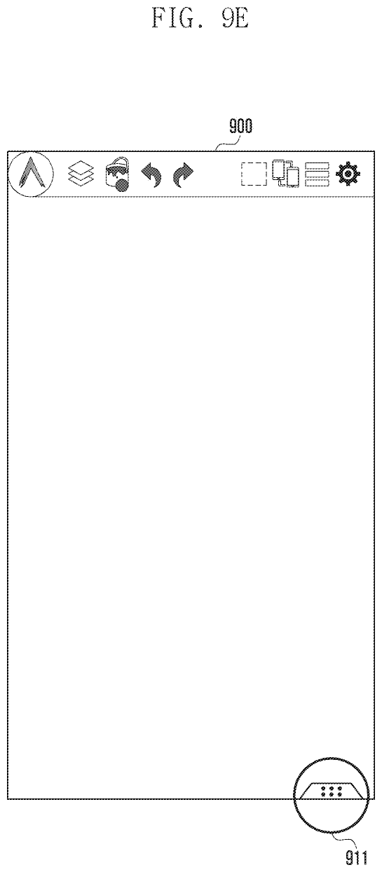

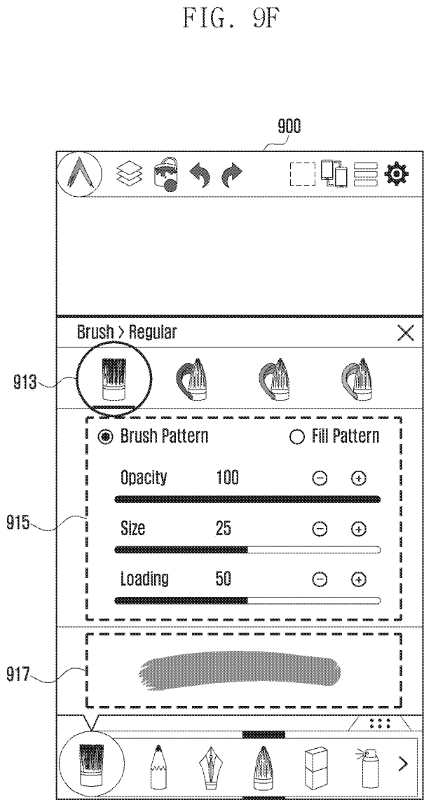

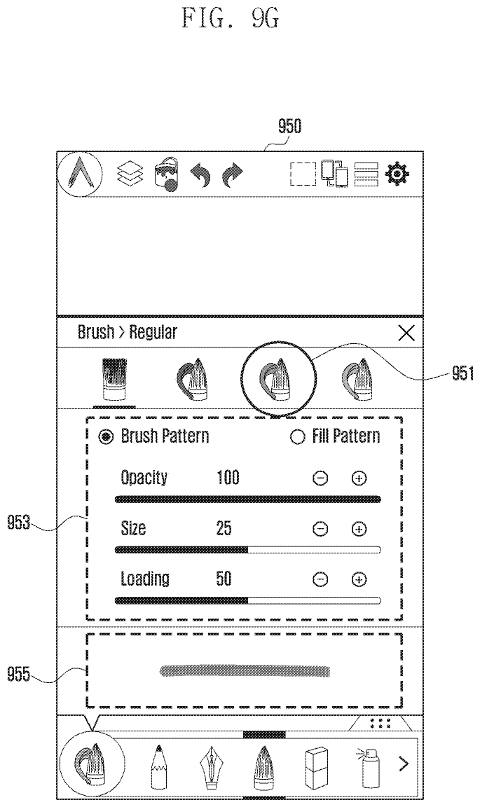

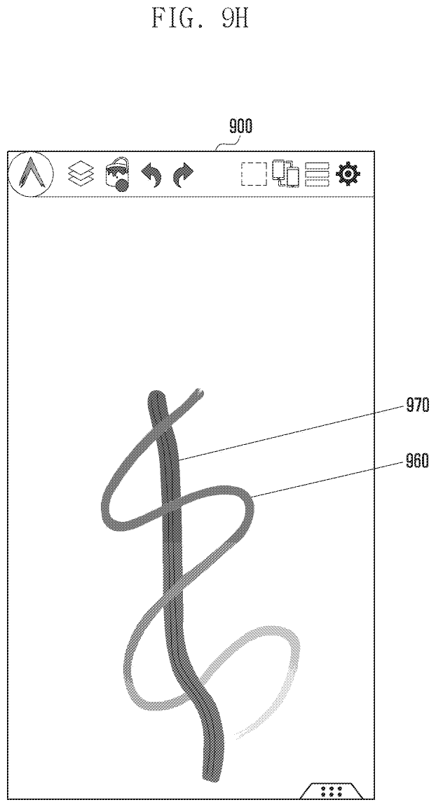

FIGS. 9A to 9H are diagrams illustrating various screen displays for explaining a collaborative drawing procedure according to various embodiments of the present disclosure.

FIG. 9A illustrates a user interface of the drawing application displayed on the screen of the electronic device 900. The user interface may display drawing tools at the bottom. The processor 210 (shown in FIG. 2) of the electronic device 900 may detect a user input made to a menu button 901 displayed at the top of the user interface.

Referring to FIG. 9B, if a user input is made to the menu button 901, the processor 210 may display a menu list 903. If a collaborative drawing item is selected in the menu list, the processor may generate a group/network for collaborative drawing. With reference to FIG. 9C, the processor 210 may display a window 907 asking whether to store the generated group/network. The processor 210 may display a collaborative drawing icon 905 indicating the state of the electronic device. With reference to FIG. 9D, the processor 210 may display a window 909 for configuring a canvas to be shared by the group/network. The processor 210 may determine the type of the canvas according to a user input. With reference to FIG. 9E, the processor 210 may determine whether to display a tool box at the bottom of the user interface according to a user input made to the tool display button 911.

Referring to FIG. 9F, the processor 210 may display an interface for detailed configuration of the drawing tool. The processor 210 may highlight a tool 913 selected by the user and display setting bars for fine confirmation of the selected tool 913. The processor 210 may also display a sample stroke 917 of the selected tool 913. The processor 210 may also display a brush pattern and fill pattern tool 915.

Referring to FIG. 9G, another electronic device connected to the electronic device 900 displays a detailed drawing tool configuration interface. FIG. 9G shows a screen display of the electronic device 950. The electronic device 950 may be in the state of being connected to the electronic device 900 via the drawing application. The electronic device 950 may highlight the tool 951 selected by the user. The electronic device 950 may display setting bars 953 for fine configuration of the selected tool 951. The electronic device 950 may also display a sample stroke 955 of the selected tool 951.

FIG. 9H illustrates an exemplary screen display for explaining the collaborative drawing on the canvas shared by the connected electronic devices 900 and 950. Although FIG. 9H shows the screen of the electronic device 900, the same screen may be displayed on the electronic device 950. The electronic device 900 may be in the state where the user is drawing a first line 970 with a configured tool. The other electronic device 950 may be in the state where the user is drawing a second line 960 with a configured tool. The electronic devices 900 and 950 may be connected to each other to communicate data and share events occurring at the respective electronic devices in real time. Accordingly, the electronic device 900 may display the events occurring at the electronic devices 900 and 950 in real time without any delay.

According to various embodiments, the collaborative drawing method is capable of facilitating collaborative drawing in such a way of checking events occurring in response to the user input and sharing, whenever an event occurs, the information concerning the checked event in real time.

As described above, the collaborative drawing method and electronic device of the present disclosure are advantageous in terms of subdividing a drawing action. For example, if the user draws a stroke, the electronic device may subdivide the drawing action into a “stroke start”, “stroke in progress”, and “stroke end”. In this way, it is possible to reduce the size of data transmitted from one electronic device to another efficiently, thereby achieving real time operation. The collaborative drawing method and electronic device of the present disclosure is advantageous in terms of facilitating collaboration of the users participated in drawing the same picture.

Also, the collaborative drawing method and electronic device of the present disclosure is advantageous in terms of minimizing drawing lag.

At least part of the method (e.g., operations) or system (e.g., modules or functions) according to various embodiments can be implemented with instructions as programming modules that are stored in computer-readable storage media. One or more processors (e.g., processor 120) can execute instructions, thereby performing the functions. An example of the computer-readable storage media may be a memory 130. At least part of the programming modules can be implemented (executed) by a processor. At least part of the programming module may include modules, programs, routines, sets of instructions or processes, etc., in order to perform one or more functions.

Examples of computer-readable media include: magnetic media, such as hard disks, floppy disks, and magnetic tape; optical media such as compact disc read only memory (CD-ROM) disks and digital versatile disc (DVD); magneto-optical media, such as floptical disks; and hardware devices that are specially configured to store and perform program instructions (e.g., programming modules), such as read-only memory (ROM), random access memory (RAM), flash memory, etc. Examples of program instructions include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

Modules or programming modules according to various embodiments may include one or more components, remove part of them described above, or include new components. The operations performed by modules, programming modules, or the other components, according to various embodiments, may be executed in serial, parallel, repetitive or heuristic fashion. Part of the operations can be executed in any other order, skipped, or executed with additional operations.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device for drawing a picture, the electronic device comprising:
a wireless communication unit;
a display;
at least one processor electrically connected to the wireless communication unit and the display; and
a memory electrically connected to the at least one processor, wherein the memory is configured to store instructions which, when executed, cause the at least one processor to:
connect, in response to executing a drawing application, to at least one other electronic device through the wireless communication unit,
transmit first tool information corresponding to the electronic device to the at least one other electronic device,
receive second tool information corresponding to the at least one other electronic device from the at least one other electronic device,
recognize, when detecting a user drag input having a length longer than a predetermined length or a user drag input for a time period longer than a predetermined time period, a portion of the user drag input as a moving event,
transmit first drawing information corresponding to the recognized moving event to the at least one other electronic device,
display the first drawing information on the display based on the first tool information,
receive second drawing information from the at least one other electronic device, and
display the second drawing information on the display based on the second tool information.

2. The electronic device of claim 1, wherein the instructions cause the at least one processor to:
generate at least one of a group or a channel based on the drawing application, and
establish a connection with the at least one other electronic device via the at least one of the group or the channel.

3. The electronic device of claim 2, wherein the instructions cause the at least one processor to:
share, in response to joining the at least one of the group or the channel, the first tool information and the second tool information.

4. The electronic device of claim 1, wherein the instructions cause the at least one processor to:
monitor to detect at least one of a start event, the moving event, and a end event based on predetermined event occurrence conditions, and
share, when the at least one event is detected, the at least one event with the at least one other electronic device.

5. The electronic device of claim 4,
wherein the start event occurs when the user input starts,
wherein the moving event occurs in association with the predetermined time period and movement direction change of the user input, and
wherein the end event occurs when the user input ends.

6. The electronic device of claim 1, wherein the instructions cause the at least one processor to:
detect the start event when the user input starts and the end event when the user input ends.

7. The electronic device of claim 1, wherein the instructions cause the at least one processor to:
detect the moving event when the user input moves as long as a predetermined distance or accumulative user input data reaches a predetermined data amount.

8. The electronic device of claim 1, wherein the instructions cause the at least one processor to:
share picture drawing information with the at least one other electronic device in real time based on the drawing application.

9. The electronic device of claim 7, wherein the picture drawing information comprises information on a drawing tool related to the user input.

10. The electronic device of claim 1, wherein the first tool information and the second tool information comprise at least one of a brush type, a brush boldness, or a color of a brush.

11. A collaborative drawing method of an electronic device, the method comprising:
connecting, in response to executing a drawing application, to at least one other electronic device;
transmitting, by at least one processor, first tool information corresponding to the electronic device to the at least one other electronic device;
receiving, by the at least one processor, second tool information corresponding to the at least one other electronic device from the at least one other electronic device;
recognizing, by the at least one processor, when detecting a user drag input having a length longer than a predetermined length or a user drag input for a time period longer than a predetermined time period, a portion of the user drag input as a moving e vent;
transmitting, by the at least one processor, first drawing information corresponding to the recognized moving event to the at least one other electronic device;
displaying, by the at least one processor, the first drawing information on the display based on the first tool information;
receiving, by the at least one processor, second drawing information from the at least one other electronic device; and
displaying, by the at least one processor, the second drawing information on the display based on the second tool information.

12. The method of claim 11, wherein the connecting of the electronic device to the at least one other electronic device comprises:
generating, by the at least one processor, at least one of a group or a channel based on the drawing application, and
establishing, by the at least one processor, a connection with the at least one other electronic device via the at least one of the group or the channel.

13. The method of claim 12, wherein the method further comprises:
sharing, in response to joining the at least one of the group or the channel, the first tool information and the second tool information.

14. The method of claim 11, wherein the detecting of the event comprises:
monitoring to detect at least one of a start event, the moving event, and a end event based on predetermined event occurrence conditions, and
sharing, when the at least one event is detected, the at least one event with the at least one other electronic device.

15. The method of claim 14,
wherein the start event occurs when the user input starts,
wherein the moving event occurs in association with the predetermined time period and movement direction change of the user input, and
wherein the end event occurs when the user input ends.

16. The method of claim 11, wherein the detecting of the event comprises detecting the start event when the user input starts and the end event when the user input ends.

17. The method of claim 11, wherein the detecting of the event comprises detecting the moving event when the user input moves as long as a predetermined distance or accumulative user input data reaches a predetermined data amount.

18. The method of claim 11, wherein the method further comprises:
sharing picture drawing information with the at least one other electronic device in real time based on the drawing application.

19. The method of claim 18, wherein the picture drawing information comprises information on a drawing tool related to the user input.

20. The method of claim 11, wherein the first tool information and the second tool information comprise at least one of a brush type, a brush boldness, or a color of a brush.
